(19) United States
(12) Patent Application Publication
(10) Pub. No.: US 2016/0376900 A1
(43) Pub. Date: Dec. 29, 2016

(54) STATOR DEVICE FOR A CONTINUOUS-FLOW MACHINE WITH A HOUSING APPLIANCE AND MULTIPLE GUIDE VANES

(71) Applicant: Rolls-Royce Deutschland Ltd & Co KG, Blankenfelde-Mahlow (DE)

(72) Inventor: Markus GOLLER, Berlin (DE)

(21) Appl. No.: 15/192,388

(22) Filed: Jun. 24, 2016

(30) Foreign Application Priority Data
Jun. 25, 2015 (DE) 10 2015 110 252.8

(51) Int. Cl. F01D 11/00; F01D 17/16; F01D 25/00; F01D 9/04

(52) U.S. Cl. CPC F01D 11/003; F01D 9/041; F01D 17/162; F01D 25/005; F05D 2220/323; F05D 2240/12; F05D 2240/58; F05D 2300/432

(57) ABSTRACT

A stator device for a continuous-flow machine with a housing appliance and multiple guide vanes that are arranged in a circumferentially distributed manner at the housing appliance. The guide vanes are respectively embodied with a blade leaf and respectively at least one platform. At least in certain areas, the platforms form a surface of an annular channel through which working fluid flows during operation of the stator device, and are mounted so as to be adjustable with respect to the housing appliance. Here, a gap area is provided that at least in certain areas is formed by a radial gap—with respect to a longitudinal axis of the platform 4—between the platform and the housing appliance in the area of the surface of the annular channel. A sealing appliance is provided in the area of the gap.

The invention relates to a stator device for a continuous-flow machine, in particular an aircraft engine, with a housing appliance and multiple guide vanes according to the kind as it is more closely defined in patent claim 1.

Stator devices of compressors of aircraft engines that are embodied with guide vanes that are designed so as to be adjustable around a central axis are generally known from practice. Here, the guide vanes that are arranged in a circumferentially distributed manner inside a housing appliance have respectively one external housing and a platform that connects in the radially outward direction of the stator device and that is also referred to as a penny, wherein, together with the housing appliance, the platforms delimit a core flow channel of the aircraft engine in the radial direction of the stator device. Also connecting in the radial direction of the aircraft engine, on a side of the platforms that is facing away from blade leaf, is respectively one spindle-shaped area via which the guide vanes are mounted so as to be twistable around a central axis of the spindle-shaped area with respect to the housing appliance. The platform, which is embodied with a circular cross-section with respect to the central axis of the spindle-shaped area, has a larger cross-section with respect to the central axis of the spindle-shaped area than the spindle-shaped area. The platforms are respectively mounted in a recess of the housing appliance that is concentric with respect to the central axis of the spindle-shaped area, wherein the housing appliance and the platform are arranged at a distance from each other in the radial direction of the central axis of the spindle-shaped area, so that a circumferential gap is present between the housing appliance and the platforms of the guide vanes. Also, a surface of the platforms that is facing away from the core flow channel is arranged at a distance with respect to the housing appliance in the radial direction.

A continuous-flow machine that is embodied with such a stator device has the disadvantage that it has an unsatisfactory level of efficiency.

The present invention is based on the objective of providing a stator device, wherein a level of efficiency of such a continuous-flow machine that is embodied with such a stator device is improved.

According to the invention, this objective is achieved by means of a stator device with the features of patent claim 1.

What is suggested is a stator device of a compressor or a turbine for a continuous-flow machine, in particular an aircraft engine or a stationary gas turbine, with a housing appliance and multiple guide vanes that are arranged at the housing appliance in a circumferentially distributed manner, wherein the guide vanes are respectively embodied with a blade leaf and respectively at least one platform (penny). At least in certain areas, the platforms form a surface of an annular channel through which a working fluid flows in operation of the stator device and are mounted in an adjustable manner with respect to the housing appliance, wherein a gap area is provided that is formed at least in certain areas by a radial gap with respect to a longitudinal axis of the platform between the platform and the housing appliance in the area of the surface of the annular channel. According to the invention, a sealing appliance is provided in the area of the gap.

The solution according to the invention is based on the insight that in stator devices that are embodied in a conventional manner, a part of the working fluid that is conducted through the annular channel in operation of a continuous-flow machine is conducted as a leakage flow through the gap area which in addition to the radial gap can also be formed by an axial clearance—with respect to the longitudinal axis of the platform—between a surface of the platform that is facing away from the annular channel and the housing appliance. This leakage flow is conducted through the gap area due to a pressure difference between the pressure side and the suction side of the blade leaf or an increasing pressure gradient in the flow direction of the working fluid inside the annular channel, wherein the leakage flow is in particular guided via the gap in the area of the downstream pressure side of the blade leaf and the side of the platform that is facing away from the annular channel to an upstream suction side of the blade leaf, and there via the gap into the annular channel. As the leakage flow flows out from the gap area in the area of the suction side of the blade leaf, the leakage flow exiting from the gap area interacts with the main flow of the working fluid in the annular channel, wherein a so-called blockage area occurs in the main flow, having a reduced flow velocity as compared to surrounding areas of the main flow. This effect results in the leakage flow having a significant negative impact on the continuous-flow machine's level of efficiency.

Providing the sealing appliance in the solution according to the invention has the advantage that the gap area can be sealed in operation of the stator device at least in certain areas in the radial direction of the stator device or in the axial direction of the longitudinal axis of the platform, so that a mass flow of the leakage flow entering the main flow of the annular channel from the gap in the area of the suction side of the blade leaf, is reduced or an inflow of leakage flow into the annular channel in the area of the suction side of the blade leaf is completely avoided.

A lossy interaction of the leakage flow with the main flow is thus reduced or completely eliminated, so that a level of efficiency is increased in a continuous-flow machine that is embodied with a stator device according to the invention as compared to known embodiments without such a sealing appliance.

This also results in a reduced specific fuel requirement of a continuous-flow machine that is embodied with a stator device according to the invention, wherein this represents a significant advantage in particular in an aircraft engine.

The leakage flow through the gap area is particularly strongly reduced if the sealing appliance extends in the radial direction—with respect to the longitudinal axis of the platform—from the platform up to the housing appliance and thus radially overlaps with the entire gap.

In an advantageous embodiment of the stator device according to the invention, it can be provided that the sealing appliance is embodied in such a manner that it at least approximately encircles the platform with respect to the longitudinal axis of the platform. Here, the leakage flow in the area of the gap can be completely eliminated.

The sealing in the area of the gap between the platform and the housing appliance is particularly effective if the sealing appliance is arranged in an area of the gap that is adjacent to the annular channel. In such an embodiment of the invention, a leakage flow can also be avoided around the platform in an area proximate to the annular channel.

In an embodiment of the invention that is characterized by a long service life, the sealing appliance is made of a particularly high-temperature resistant material, such as for example polytetrafluorethylene, or the like.

Constructionally, the sealing appliance can be arranged in the area of the gap in a particularly simple manner if the sealing appliance is arranged at least in certain areas inside a groove of the platform and/or a groove of the housing appliance that is substantially oriented in the radial direction with respect to the central axis.

A stator device that is embodied in a simple and cost-effective manner is present when the sealing appliance is embodied as an O-ring, as a piston ring with ends that are arranged at a distance form each other in particular in the circumferential direction, or as a shaft seal ring.

The platform of the guide vane can be arranged in an inner and/or an outer edge area of the blade leaf with respect to the radial direction of the stator device, wherein a sealing appliance is preferably arranged in the area of each platform in a gap between the respective platform and the housing appliance.

The features specified in the patent claims as well as the features specified in the following exemplary embodiments of the stator device according to the invention are respectively suitable on their own or in any combination with each other to further develop the subject matter according to the invention.

Further advantages and advantageous embodiments of a stator device according to the invention follow from the patent claims and the exemplary embodiments that are described in principle in the following by referring to the drawing, wherein, with a view to clarity, the same reference numbers are respectively used for structurally and functionally identical structural components.

Herein:

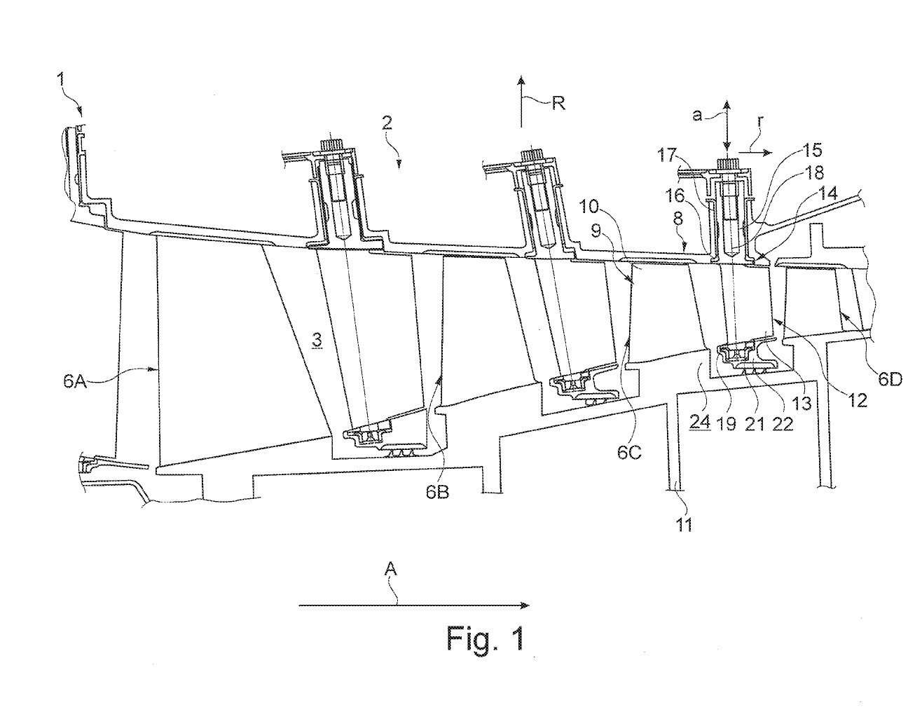

FIG. 1 shows a strongly schematized longitudinal section view of a section of a jet engine, wherein a compressor with multiple rotor devices and stator devices is shown, which respectively have blades that protrude into a core flow channel;

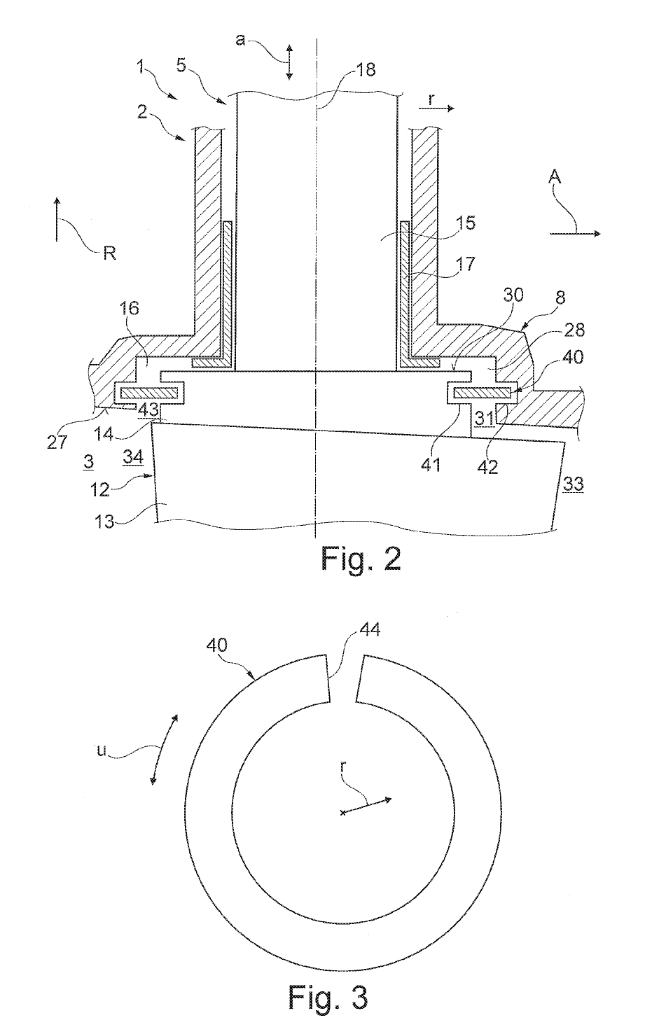

FIG. 2 shows a simplified longitudinal section rendering through a part of the stator device of FIG. 1, wherein a sealing appliance that is arranged in the area of a gap between the platform and a housing appliance is shown in a first embodiment,

FIG. 3 shows a strongly simplified rendering of the sealing appliance in isolation;

FIG. 4 shows a view of the stator device according to FIG. 1 corresponding to FIG. 2, wherein a second embodiment of the sealing appliance is shown;

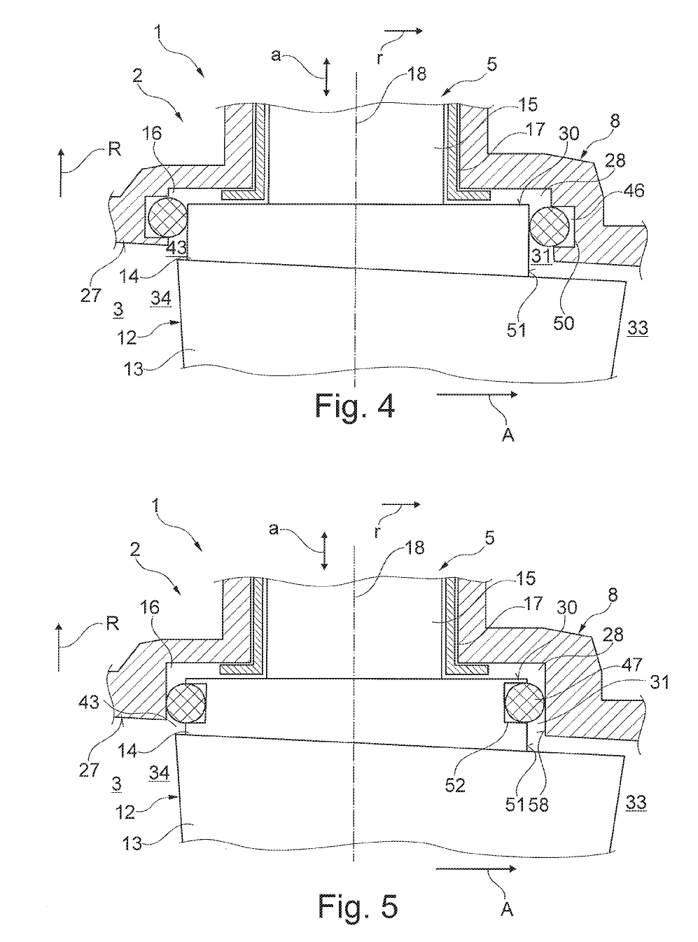

FIG. 5 shows a view of the stator device according to FIG. 1 corresponding to FIG. 2 and FIG. 4, wherein a third embodiment of the sealing appliance is shown; and

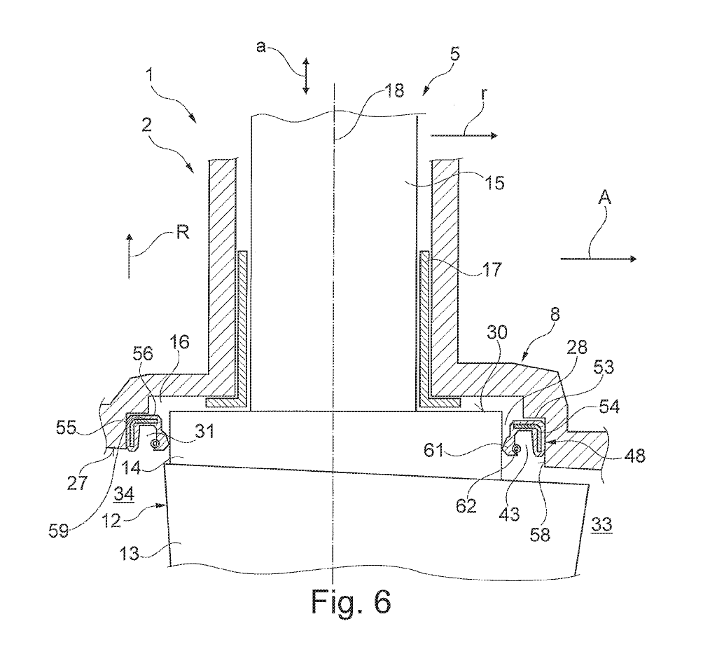

FIG. 6 shows a view of the stator device according to FIG. 1 corresponding to FIG. 2, FIG. 4 and FIG. 5, with a sealing appliance in a fourth embodiment.

FIG. 1 shows a section of a continuous-flow machine, which in the present case is embodied as the jet engine 1 of an airplane, but can also be a stationary gas turbine in an alternative embodiment. In the section an annular channel or core flow channel 3 of the jet engine 1 is shown in the area of a blade wheel device that is embodied as a high-pressure compressor 2, wherein different stages 6A, 6B, 6C, 6D of the high-pressure compressor 2 can be seen that respectively consist of a rotor device 4 and a stator device 5 that is arranged in the axial direction A of the jet engine 1 downstream of the rotor device 4.

In the following, the rotor device 4 and the stator device 5 of the third stage 6C of the high-pressure compressor 2 are described in more detail, wherein the rotor devices 4 and the stator devices 5 of the other stages 6A, 6B, 6D are embodied in a comparable manner.

The rotor device 4 has a plurality of rotor blades 9 that are embodied as blade leafs 10 and that are operationally connected in a circumferentially distributed manner to a disc wheel 11 and rotate around a central axis of the jet engine 1 during operation of the jet engine 1. In contrast, the stator device 5 is embodied with a plurality of guide vanes 12 that also have respectively one blade leaf 13, wherein the guide vanes 12 that are respectively embodied in a constructionally identical way are arranged at the outside of the housing appliance 8 in a circumferentially distributed manner in the radial direction R of the jet engine 1.

In the radial direction R of the jet engine 1, the blade leafs 13 of the guide vanes 12 outwardly adjoin respectively one platform 14 or so-called penny. The platforms or pennies 14 at least in certain areas delimit the core flow channel 3 in the radial direction R of the jet engine 1 and are respectively connected to one spindle-shaped area 15 as seen from the radially outward direction, and in the present case are embodied integrally with the same. Here, the platforms 14 have a larger cross-section with respect to a central axis 18 of the spindle-shaped area 15 than the spindle-shaped area 15. The guide vanes 12 are arranged inside recesses 16 of the housing appliance 8 with the platforms 14 and the spindle-shaped areas 15, wherein the spindle-shaped areas 5 are mounted inside the recesses 16 via sockets 17.

The guide vanes 12 are arranged in the known manner inside the recesses 16 of the housing appliance 8 so as to be twistable around the central axis 18 of the spindle-shaped area 15, which is coextensive to the longitudinal axis of the platform 14, wherein the guide vanes 12 can for example be twisted via the spindle-shaped areas 15 by 5° to 60° with respect to the housing appliance 8.

A platform 19 is also provided on an inner side of the blade leaf 13, with respect to the radial direction R of the jet engine 1 or of the stator device 5, being embodied in a comparable manner to platform 14 with a spindle-shaped area 20 and delimitating the core flow channel 3 at least in certain areas in the radial direction R of the jet engine 1. Through the spindle-shaped area 20, the guide vane 12 is mounted via a socket 21 inside a housing part 22 of the housing appliance 8, a so-called shroud, wherein the guide vane 12 is mounted so as to be rotatable around the central axis 18 with respect to the housing part 22. Here, the housing part 22 is arranged in its entirety inside a recess 24, which is formed by two rotor devices 4 that are adjacent to each other in the axial direction A of the jet engine 1 or of the stator device 5. During operation of the jet engine, the area of the rotor device 4 that is facing towards the housing part 22 rotates about the engine axis, while the housing part 22 is stationary with respect to the engine axis.

Shown more closely in FIG. 2 is a section of the stator device 5 with a spindle-shaped area 15 and the platform 14 of the guide vane 12. As can be seen here, the platform 14 that is embodied with a circular cross-section and the spindle-shaped area 15 that is also embodied with a circular cross-section are mounted inside the recess 16 of the housing appliance 8, which is embodied in a concentric manner with respect to the central axis 18. Here, a gap 28 is present in the area of a surface 27 of the core flow channel 3 between the platform 14 and the housing appliance 8, that runs circumferentially around the central axis 18 in the radial direction r and substantially extends outwards in the axial direction a of the central axis 18, starting at the surface 27 of the core flow channel 3.

As can further be seen from FIG. 2, a surface 30 of the platform 14 that is facing away from the core flow channel 3 is arranged at a distance from the housing appliance 8 in the radial direction R of the jet engine 1. Through this axial distance with respect to the central axis 18 of the spindle-shaped area 15 as well as trough the radial gap 28 with respect to the central axis 18, a gap area 31 is formed.

In operation of the jet engine 1, the pressure of a working fluid, which is air in the present case, increases inside the core flow channel 3 in the area of the high-pressure compressor 2 in the axial direction A of the jet engine 1 and thus in flow direction, so that a pressure of a main flow that is flowing through the core flow channel 3 is higher on the pressure side 33 of the blade leaf 13 of the guide vane 12 than at a suction side 34 of the blade leaf 13. Due to these pressure conditions, in operation of conventionally embodied jet engines 1, a part of the main flow flows as leakage flow from the pressure side 33 of the blade leaf 13 through the gap area 31 to the suction side 34 of the blade leaf 13. At that, the leakage flow is supplied from the pressure-side area of the gap 28 to the suction-side area of the gap 28 via the surface 30 that is facing away from the core flow channel 3.

In known jet engines, considerable losses occur as the leakage flow flows into the main flow in the area of the suction side 34 of the blade leaf 10, since the velocity of the main flow is undesirably reduced to a considerable extent by the leakage flow in this area and a so-called blockage or loss area is formed.

In order to reduce or completely avoid the mass flow of the leakage flow, which in operation of the jet engine 1 is introduced into the main flow at the suction side 34 of the blade leaf 13, a sealing appliance that is embodied as a piston ring 40 is provided in FIG. 2, which is arranged inside the gap 28 and can be seen in isolation in FIG. 3.

Here, the piston ring 40, which in the present case is embodied with resistant polytetrafluoroethylene, is arranged inside a groove 41 of the platform 14 as well as inside a groove 42 of the housing appliance 8, so that a width of the gap 28 is completely covered by a piston ring 40 in the radial direction r with respect to the central axis 18. In order to be able to mount the piston ring 40 in a simple manner, it is embodied with a recess 44 in the manner of a ring disc. Thus, in the mounted state, the piston ring 40 almost completely encircles the central axis 18 in the circumferential direction.

The piston ring 40 is preferably arranged inside the gap 28 in an area that directly adjoins the core flow channel 3 or a surface 27 of the core flow channel 3, so that a flow area 43 that is present inside the piston ring 40 in the radial direction R of the jet engine 1 is minimized or completely eliminated. The closer to the surface 27 of the core flow channel 3 the piston ring 40 is arranged in the area of the gap 28, the smaller the flow area 43 and therefore also the leakage flow during operation of the jet engine 1.

By means of the piston ring 40, is can be achieved in a simple manner that no leakage flow or only an amount of leakage flow that is strongly reduced as compared to conventional embodiments without a piston ring 40 flows on a side of the piston ring 40 that is facing away from the core flow channel 3 during operation of the jet engine 1.

In FIG. 4 to FIG. 6, embodiment variants of a sealing appliance 46, 47, 48 are shown that are alternatives to the piston ring, wherein only the differences to the embodiment described more closely above will be pointed out in the following.

The sealing appliance 46 according to FIG. 4 is embodied as an O-ring, wherein the O-ring 46 is supported in its position via a groove 50 that is provided inside the housing appliance 8. Here, the O-ring 46 abuts a lateral surface 51 of the platform 14 that substantially extends in the radial direction R of the jet engine 1. Due to the fact that the O-ring 46 is embodied so as to run around the entire circumference of the central axis 18 in its circumferential direction u and to completely seal the gap 28 in the radial direction r of the central axis 18, it is achieved in a particularly safe manner by means of this embodiment that working gas can flow as leakage flow at a side of the O-ring 46 that is facing away from the core flow channel 3.

What is shown according to FIG. 5 is a sealing appliance 47 that is also embodied as an O-ring, but in contrast to the sealing appliance 46 is arranged inside a groove 52 provided in the platform 14. Here, the O-ring 47 abuts a lateral surface 58 of the housing appliance 8 that extends substantially in the radial direction R of the jet engine 1. The O-ring 47 has a comparable effect to the O-ring 46 and is also embodied so as to completely run around the central axis 18 in its circumferential direction u, so that also in this embodiment the gap 28 is completely sealed in the radial direction r of the central axis 18.

In FIG. 6, the sealing appliance is embodied as a shaft seal ring 48 that abuts the housing appliance 8 in the area of a ledge 53. The shaft seal ring 48 is also embodied with polytetrafluoroethylene, but has an integrated reinforcement 54. The reinforcement 54 is embedded inside a leg 55 that extends in the radial direction R of the jet engine 1 and, in the mounted state, acts together with the lateral surface 58 of the housing appliance 8 that substantially extends in the axial direction with respect to the central axis 18. Further, the reinforcement 54 has an area 56 that extends substantially in the radial direction r with respect to the central axis 18 and that is embodied as a circular ring. In the mounted state, the shaft seal ring 48 acts together with a surface 59 of the housing appliance 8 via the area 56, with the surface 59 of the housing appliance 8 also extending substantially in the radial direction r with respect to the central axis 18.

Further, the shaft seal ring 48 has a sealing lip 61 that is embodied for acting together with the lateral surface 51 of the platform 14. In order to press the sealing lip 61 onto the platform 14 with a desired contact pressing force during operation of the jet engine 1, the shaft seal ring 48 has a tensioning means that is embodied as a tensioning spring 62. The tensioning spring 62 is arranged at a side of the sealing lip 61 that is facing away from the platform 14 in the radial direction r of the central axis 18 and is embodied in a circumferentially extending manner.

In all embodiment variants of the sealing appliance 40, 46, 47, 48, the sealing appliance 40, 46, 47, 48 acts together with the platform 14 and/or the housing appliance 8 in such a way that the guide vane 12 can be adjusted around the central axis 18 in a simple manner. The contact pressing forces of the sealing appliance 40, 46, 47, 48 onto the platform 14 and/or the housing appliance 8 are correspondingly set to a predefined value.

A sealing appliance can also be arranged in the area of the platform 19 in a comparable manner and analogous to the arrangement of the sealing appliances 40, 46, 47, 48 in the area of the platform 14, wherein the sealing appliance can be arranged between the platform 19 and the housing part 22 inside the gap 28 that is formed by these structural components in the radial direction r with respect to the central axis 18.

### Parts list

1 continuous-flow machine; jet engine
2 blade wheel device; high-pressure compressor
3 core flow channel, annular channel
4 rotor device
5 stator device
6A to 6D stages of the high-pressure compressor
8 housing appliance
9 rotor blade
10 blade leaf of the rotor blade
11 disc wheel
12 guide vane
13 blade leaf of the guide vane
14 platform, penny
15 spindle-shaped area
16 recess of the housing appliance
17 socket
18 central axis
19 platform
20 spindle-shaped area
21 socket
22 housing part
24 recess
27 surface of the core flow channel
28 gap
30 surface of the platform
31 gap area
33 pressure side of the blade leaf
34 suction side of the blade leaf
40 sealing appliance, piston ring
41 groove of the platform
42 groove of the housing appliance
43 flow area
44 recess of the piston ring
46 sealing appliance, O-ring
47 sealing appliance, O-ring
48 sealing appliance, shaft seal ring
50 groove of the housing appliance
51 lateral surface of the platform
52 groove of the platform
53 ledge of the housing appliance
54 reinforcement of the shaft seal ring
55 leg of the shaft seal ring
56 area of the shaft seal ring
58 lateral surface of the housing appliance
59 surface of the housing appliance
61 sealing lip of the shaft seal ring
62 tensioning means; tensioning spring
a axial direction of the guide vane
A axial direction of the jet engine
r radial direction guide vane
R radial direction of the jet engine
u circumferential direction to the central axis of the guide vane
U circumferential direction of the jet engine

1. A stator device for a continuous-flow machine with a housing appliance and multiple guide vanes that are arranged in a circumferentially distributed manner at the housing appliance, wherein the guide vanes are respectively embodied with a blade leaf and respectively at least one platform, wherein the platforms at least in certain areas form a surface of an annular channel through which working fluid flows in operation of the stator device, and wherein they are mounted so as to be adjustable with respect to a housing appliance, and wherein a gap area is provided that is formed at least in certain areas by a radial gap—with respect to a longitudinal axis of the platform—between the platform and the housing appliance in the area of the surface of the annular channel, wherein a sealing appliance is provided in the area of the gap.

2. The stator device according to claim 1, wherein the sealing appliance extends in the radial direction with respect to the longitudinal axis of the platform from the platform to the housing appliance.

3. The stator device according to claim 1, wherein the sealing appliance is embodied so as to circumferentially surround the platform at least approximately with respect to the longitudinal axis of the platform.

4. The stator device according to claim 1, wherein the sealing appliance is arranged in an area of the gap that is adjacent to the annular channel.

5. The stator device according to claim 1, wherein the sealing appliance is embodied with a temperature-resistant material, in particular polytetrafluoroethylene.

6. The stator device according to claim 1, wherein the sealing appliance is arranged at least in certain areas inside a groove of the platform that is substantially oriented in the radial direction with respect to the central axis.

7. The stator device according to claim 1, wherein the sealing appliance is arranged at least in certain areas in a groove of the housing appliance that is substantially pointing in the radial direction with respect to the central axis.

8. The stator device according to claim 1, wherein the sealing appliance is embodied as an O-ring.

9. The stator device according to claim 1, wherein the sealing appliance is embodied as a piston ring.

10. The stator device according to claim 1, wherein the sealing appliance is embodied as a shaft seal ring.

11. The stator device according to claim 1, wherein the platform of the guide vane is arranged in an inner and/or outer edge area of the blade leaf with respect to the radial direction of the stator device, wherein in the area of each platform a sealing appliance is preferably arranged inside the gap between the respective platform and the housing appliance.
